(19) United States
(12) Patent Application Publication
(10) Pub. No.: US 2003/0024867 A1
(43) Pub. Date: Feb. 6, 2003

(54) Bactericidal descaler, particularly for treating drinking water

(75) Inventor: Francesco Favarin, Carrare (IT)

Correspondence Address: MODIANO & ASSOCIATI, Via Meravigli, 16, MILANO, 20123, IT

(73) Assignee: TECNOACQUE DI FAVARIN FRANCESCO & C. S.N.C.

(21) Appl. No.: 10/153,602

(22) Filed: May 24, 2002

(30) Foreign Application Priority Data
Aug. 2, 2001 (IT) TV2001U000043

(51) Int. Cl. C02F 1/48

(52) U.S. Cl. 210/222

(57) ABSTRACT

A bactericidal descaler particularly for the treatment of water used for drinking, comprising a coil which is supplied electrically with a square-wave AC voltage or with a half-wave rectified voltage.

### BACKGROUND OF THE INVENTION

The present invention relates to a bactericidal descaler particularly for treating potable water, i.e. drinking water.

Devices are currently known which perform various water treatments, including devices whose function is to change the chemical-physical composition of the water, but with the aim of eliminating the deposition of scale in pipes, which can compromise their optimum heat exchange and thus increase energy consumption.

Accordingly, devices are known which need to premix the water that is used with salts, which vary the degree of hardness of the water, allowing a slight reduction in calcium salts.

Devices are also known which use chemical additives to achieve the same results; Italian Utility Model 229.250 by the same Applicant discloses a descaler, particularly for treating water used for heating and/or for sanitary applications, such descaler being constituted by an upper flange and a lower flange, which can be magnetized and can be detachably coupled one another with the interposition of one or more spacers so as to form a first annular seat for an electric coil and a separate second annular seat for conveying water from an inlet to an outlet arranged next to each other with the interposition of a flow diverter.

However, all this prior art technique only changes the chemical-physical composition of the water, which is a health detrimental operation in water that is instead designed for drinking, since the presence of calcium is a primary element for determining potability.

Moreover, in most cases such technique promotes bacterial proliferation, with a consequent risk of biological contamination of the pipes in the distribution system.

The risk of biological proliferation in the water treated by any of softeners to reverse osmosis to the normal mechanical or activated-carbon filters, is in fact very high, to the point that post-disinfection systems are at least recommended, if not legally mandatory.

The apparatus previously patented by the same Applicant also suffers the same drawback, although it has a toroidal coil supplied with direct current s whose magnetic induction facilitates, in the mineral salts that are present in the water, a regular microcrystallization of calcium bicarbonate with respect to the irregular macrocrystallization that occurs with untreated water, once it has been heated or evaporated.

### SUMMARY OF THE INVENTION

The aim of the present invention is to solve the above mentioned problems, eliminating the drawbacks of the cited prior art, by providing an apparatus for physical treatment of water suitable for drinking, that allows to achieve a considerable biological reduction.

Within this aim, an object of the invention is to provide an apparatus for the physical treatment of potable water, i.e. suitable for drinking, that decreases any biological risks in the water per se and any risks induced by the treatment used.

Another object is to obtain an apparatus for the physical treatment of water suitable for drinking that has no biological or other contraindication.

Another object is to provide an apparatus for the physical treatment of water suitable for drinking, that may be defined as having a bactericidal action, and which eliminates or reduces drastically the risk of bacterial proliferation in water thus treated and, accordingly, also in distribution networks, unlike the other known water treatment systems.

Another object is to obtain an apparatus that associates with the preceding characteristics that of having low overall and installation costs and which can be obtained with usual and known machines and equipment.

This aim and these and other objects that will become better apparent hereinafter are achieved by a bactericidal descaler, particularly for the treatment of water used for drinking, comprising an upper flange and a lower flange, which can be magnetized and mutually coupled detachably by way of suitable screws and can be mutually superimposed with the interposition of a first spacer and a second spacer, constituted by rings; a first annular seat being formed between said upper flange and said lower flange, said first seat being shaped so as to accommodate a coil which is arranged concentrically thereto, characterized in that said coil is energized with AC electric power with a square-wave voltage of 10 to 300 volts at frequencies of 2 to 60 Hz.

### BRIEF DESCRIPTION OF THE DRAWINGS

Further characteristics and advantages of the present invention will become better apparent from the following detailed description of some particular but not exclusive embodiments thereof, illustrated only by way of non-limitative example in the accompanying drawings, wherein:

FIG. 1 is a partially sectional plan view of the descaler;

FIG. 2 is a sectional view of the descaler, taken along the line II-II of FIG. 1;

FIG. 3 is an exploded sectional view of the descaler, taken along the line III-III of FIG. 1;

FIG. 4 is a reproduction of a first photograph showing the effect of the electromagnetic field on fecal coliforms in river water (A untreated water, B treated water);

FIG. 5 is a chart which plots the effect of the electromagnetic field on the total bacterial mass that is present in water of a well (A untreated water, B treated water);

FIG. 6 is a reproduction of a second photograph showing the effect of the electromagnetic field on the bacterial mass in water of a well (A untreated water, B treated water);

FIG. 7 is a reproduction of a third photograph showing the effect of the electromagnetic field on total coliforms in river water (A untreated water, B treated water);

FIG. 8 is a chart comparing the results for plasma osmolarity in fish grown in water treated as provided by the invention and in fish grown in untreated water (A untreated water, B treated water);

FIG. 9 is a chart comparing the cortisol levels found in the plasma of fish grown in water treated as provided by the present invention and in fish grown in untreated water (A untreated water, B treated water).

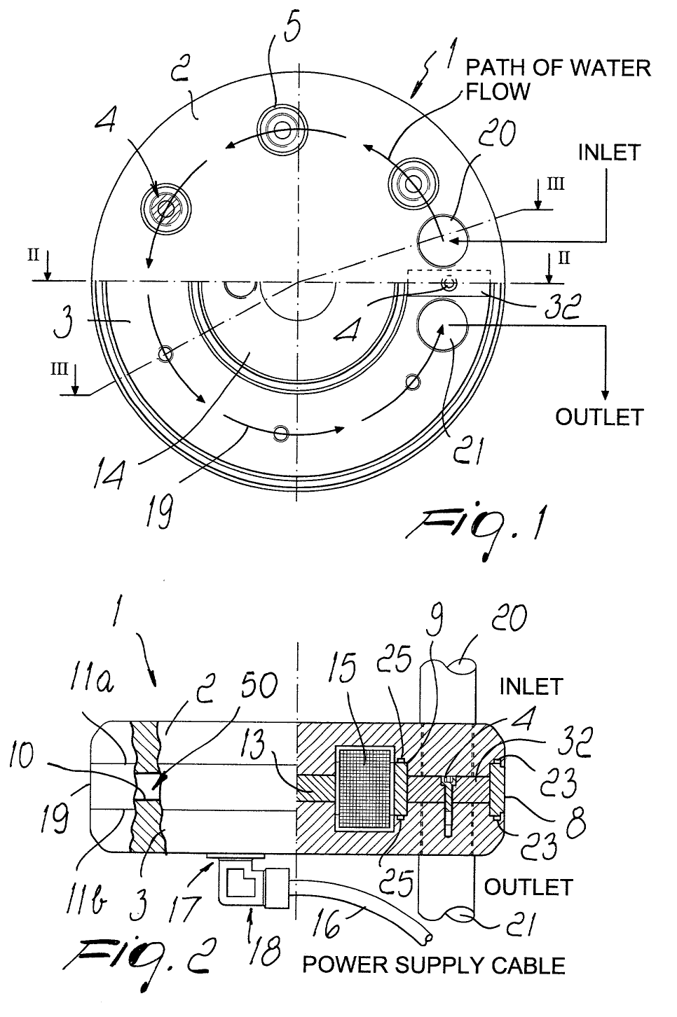

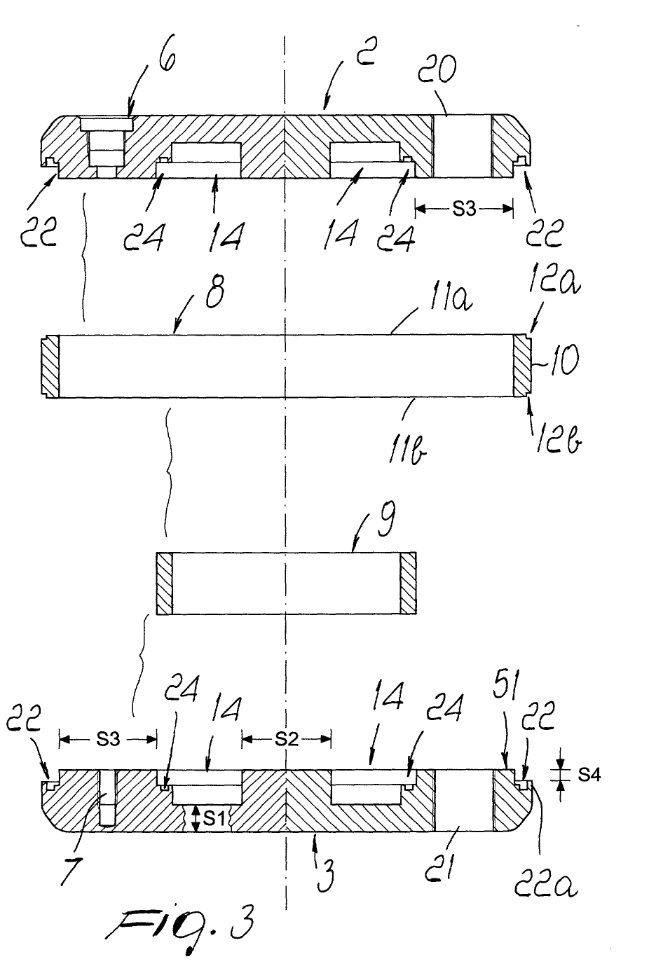

### DESCRIPTION OF THE PREFERRED EMBODIMENTS

With reference to the figures, the reference numeral 1 designates the descaler, constituted by a first upper flange 2 and a second lower flange 3, which can be magnetized and detachably coupled one another by means of suitable screws 4, whose heads 5 can be positioned at suitable seats 6 formed on the upper flange 2 and whose stems are coupled at suitable complementarily threaded channels 7 formed in the lower flange 3.

The screws 4 are made of nonmagnetizable material, in order to avoid acting as a magnetic bridge, thus ensuring maximum induction between the space interposed between the walls of the induction chamber formed by the facing surfaces of the upper and lower flanges.

The upper flange 2 and the lower flange 3 can in fact be mutually superimposed, interposing a first outer spacer 8 and a second inner spacer 9, which are constituted by rings; the first spacer 8 has, on the outer lateral surface 10 and at the peripheral edges 11a and 11b, two recesses 12a and 12b, which form, for the first spacer 8, a T-shaped cross-section whose stem is directed outward.

A suitable magnetizable gap pad 13 can be arranged at the second spacer 9.

A first annular seat 14 for a coil 15 is formed between the upper flange 2 and the lower flange 3; the coil 15 is arranged concentrically, is made of copper and is supplied with electric power by means of a suitable cable 16, which can be connected thereto by means of a suitable power supply input 17 with a cable clamp 18.

Coaxially to the first seat 14 there is a second separate seat 19, which is also annular and is designed/shaped to convey water from an inlet 20 to an outlet 21 located close to each other, with a flow diverter 32 interposed between them.

The inlet 20 and the outlet 21 are therefore arranged laterally adjacent to each other, so as to force the water to follow a path of more than 300°.

In the present device, the surfaces of the water treatment chamber (50) have been modified and improved with respect to the previous device of the Applicant in order to achieve a lower inductive leakage outside the apparatus.

The modifications applied to the described device, with respect to the one to which the previous filing of the Applicant relates, concern first of all a different type of power supply of the coil 15 and a different and more balanced sizing of some structural parts, such as the use of a metallic core (gap pad 13) which has an increased cross-section thickness S1 in order to oppose less resistance to the magnetic conductivity of the field generated by the coil 15, thus reducing interference and internal leakage; advantageously, the ratio S1=30/100 S2 is defined, where S2 (see FIG. 3) is the central cross-section extension of the upper flange 2 and lower flange 3.

Accordingly, as shown in FIG. 3, the first spacer 8 has recesses 12a and 12b obtained internally and at the peripheral edges 11a and 11b on the outer lateral surface 10, so as to form, for the first spacer 8, a T-shaped cross-section in which the stem is directed outward; the recesses are matched by appropriate first recessed cross-section configurations 22 of the flanges (which are recessed, and therefore deeper, than the plane surface of the water treatment chamber 50 with respect to the previously patented device), which have a shape that forms, once the first and second flanges have been assembled, first annular cavities 23 for sealing elements which are arranged approximately at a location that is central with respect to the radial width of the first spacer 8.

Advantageously, the ratio S4=15/100 S2 is defined for said configurations 22, where S4 is the distance between the plane of arrangement of the facing surfaces of the upper and lower flanges and the abutment region of the recesses 12a and 12b of the first spacer 8. Likewise, at the second spacer 9 there are, on the first and second flanges, second annular recessed cross-section configurations 24, which are substantially identical to the first recessed cross-section configurations 22, so as to form second annular cavities 25.

This has allowed to have a better and uniform distribution of the field on the walls that compose the induction or treatment chamber 50 in contact with the water, since the spacing provided by material removal at the configurations 22 of the magnetizable peripheral edge parts 22a, which are assigned a mere sealing function instead of an induction function, from the surface 51 of the treatment chamber 50 has allowed to decrease, also in this peripheral region, the external leakage of the magnetic field, helping to concentrate it mainly on the walls of the treatment chamber in contact with the water.

Moreover, an increase of the cross-section distance S1 and of the radial distance S3 for transmission of the first and second flanges with respect to the device described in the document filed previously by the same Applicant in order to facilitate the passage of the field inside said material, reducing its external leakage and conveying the magnetic flux more into the region of the walls that constitute the treatment chamber 50.

Advantageously, the ratio S3=113/100 S2 is defined.

The use of a flow diverter 32 whose plan shape is substantially rectangular has allowed to improve the water contact time in the treatment chamber with respect to the preceding device filed by the Applicant where a cylindrical flow diverter was provided.

Finally, it is noted that an electric power supply has been selected which has a particular range of currents, power levels and supply frequencies of the coil: by way of example, some results obtained by using the following parameters are given:

with a square-wave AC voltage of 10 to 300 volts, and with frequencies of 2 to 60 Hz;

with a half-wave rectified voltage of 10 to 30 volts, with frequencies of 40 to 60 Hz, and with field strengths of 200 to 800 gauss at the center of the treatment chamber.

Tests were conducted, using these values, at Institutes which performed test sessions in which the effects on the bacterial load of well water and on fecal coliforms and total coliforms on river water were checked.

The chemical-physical characteristics of the treated water (hardness, electrical conductivity, temperature and pH) were also checked, revealing no change.

Weekly samples of treated and untreated (reference) water were taken during the same test session for approximately 3 months, performing the corresponding microbiological tests.

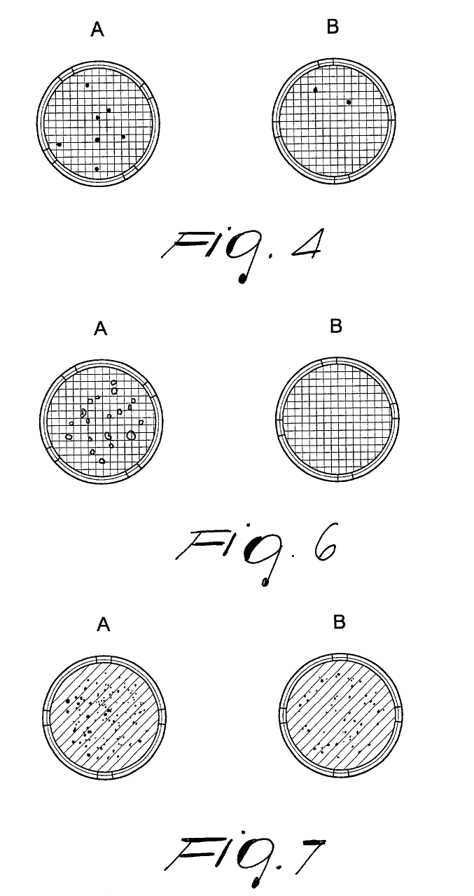

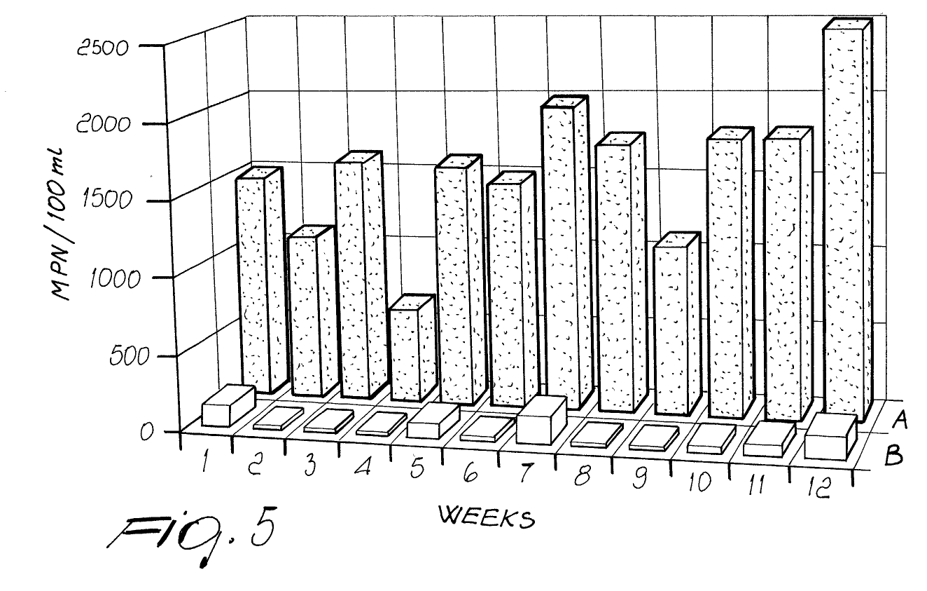

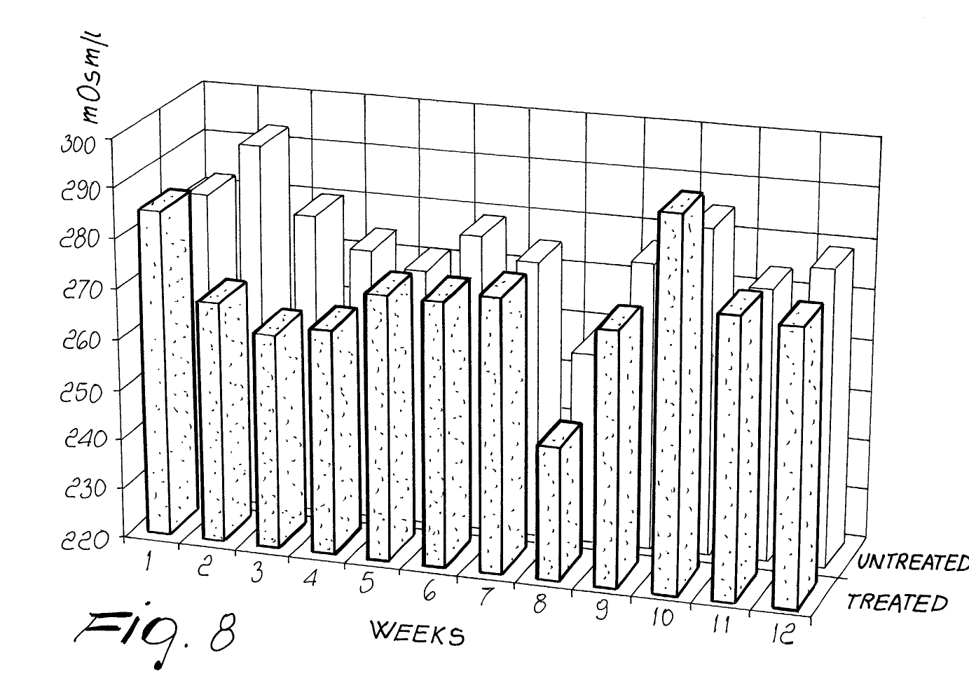

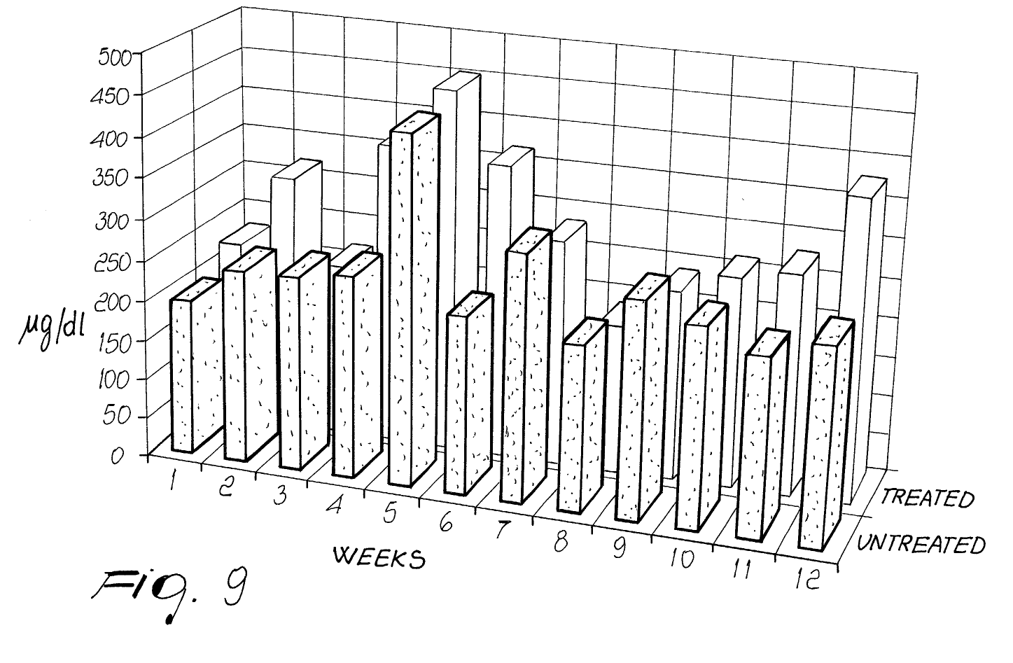

The results of this test session are shown in FIGS. 4, 6 and 7 and in the charts of FIGS. 5, 8 and 9.

It has been observed that the invention has achieved the intended aim and objects, an apparatus for the physical treatment of water suitable for drinking having been devised which allows to achieve a considerable biological reduction, reducing any biological risks both in the water per se and any risks induced by the treatment that is used, since the invention has no biological or other contraindication.

Moreover, the present invention allows to define its action as bactericidal, eliminating or reducing drastically the risk of bacterial proliferation in water thus treated and accordingly also in distribution networks.

The invention is of course susceptible of numerous modifications and variations, all of which are within the scope of the appended claims.

The materials and the dimensions that constitute the individual components of the invention may of course be more pertinent according to specific requirements.

The disclosures in Italian Utility Model Application No. TV2001U000043 from which this application claims priority are incorporated herein by reference.

What is claimed is:

1. A bactericidal descaler for the treatment of water used for drinking, comprising: fixing screws; an upper flange; a lower flange, said upper and lower flanges being made of a magnetizable material and detachably coupled to each other by way of said screws, in a superimposed configuration; a first spacer; a second spacer, constituted by rings; a first annular seat formed by said first and second spacers interposed between said upper and lower flanges so as to define a treatment chamber; and a coil accommodated in said first seat and arranged concentrically thereto, wherein said coil is energized with AC electric power with a square-wave voltage of 10 to 300 volts, at frequencies of 2 to 60 Hz.

2. A bactericidal descaler for the treatment of water used for drinking, comprising: fixing screws; an upper flange; a lower flange, said upper and lower flanges being made of a magnetizable material and detachably coupled to each other by way of said screws, in a superimposed configuration; a first spacer; a second spacer, constituted by rings; a first annular seat formed by said first and second spacers interposed between said upper and lower flanges so as to define a treatment chamber; and a coil accommodated in said first seat and arranged concentrically thereto, wherein said coil is energized with electric power with a half-wave rectified voltage of 10 to 30 volts, at frequencies of 40 to 60 Hz, and with a field strength of 200 to 800 gauss at the center of the treatment chamber.

3. A descaler for the treatment of water used for drinking, comprising: fixing screws; an upper flange; a lower flange, said upper and lower flanges being made of a magnetizable material and detachably coupled to each other by way of said screws, in a superimposed configuration; a first spacer; a second spacer, constituted by rings; a first annular seat formed by said first and second spacers interposed between said upper and lower flanges so as to define a treatment chamber; a coil accommodated in said first seat and arranged concentrically thereto; a second annular seat, forming said treatment chamber, which is coaxial to said first annular seat, for conveying water from an inlet to an outlet thereof arranged mutually adjacent; and a flow diverter interposed between said inlet and outlet, said flow diverter having, in plan view, a rectangular shape adapted to improve water contact time in said treatment chamber.

4. The descaler of claim 3, further comprising: a metallic core having a cross-section thickness S1 defined by a dimensional ratio S1=30/100 S2, wherein S2 is a central cross-section radial extension of said upper and lower flanges, adapted to oppose less resistance to magnetic conductivity of a magnetic field generated by said coil and reduce interference and internal leakage.

5. The descaler of claim 4, wherein said first spacer comprises recesses provided internally and at perimetric edges on an outer lateral surface thereof, so as to form a T-shaped cross-section shape with a stem directed outward.

6. The descaler of claim 5, wherein said screws are made of nonmagnetizable material, to prevent formation of magnetic bridges therethrough and to ensure maximum induction in a space formed between walls of the treatment chamber formed by respective facing surfaces of the upper and lower flanges.

7. The descaler of claim 6, wherein said upper and lower flanges comprise first recessed cross-section configurations which have shapes that match said recesses which form, once said first and second flanges are assembled, first annular cavities for accommodating sealing elements, said annular cavities being arranged at a central location of a radial width of said first spacer, said first cross-section configurations being provided at a distance S4 from a facing surface of each of said upper and lower flanges having a dimensional ratio S4=15/100 S2.

8. The device of claim 7, comprising second annular recessed cross-section configurations, provided at said second spacer, on said first and second flanges, which are substantially identical to said first recessed cross-section configurations, so as to form second annular cavities allowing better and uniform distribution of the magnetic field on the walls that compose the treatment chamber which are in contact with the water; and a spacing formed with respect to the facing surfaces of the upper and lower flanges defining the treatment chamber by magnetizable material removal at the first recessed cross-section configurations, which have a merely sealing function instead of an induction function and providing decreasing in perimetric regions, of any external leakage of the magnetic field, said magnetic field being lo concentrated mainly on the walls of the treatment chamber in contact with the water.

9. The descaler of claim 8, having a field transmission cross-section distance, corresponding to the thickness of said core S1 and a radial distance S3 of said first and second flanges that is increased so as to facilitate passage of the magnetic field inside said magnetizable material to reduce external leakage thereof and to convey magnetic flux more in a wall region of the treatment chamber, advantageously with a dimensional ratio S3=113/100S2.
